(19) United States
(12) Patent Application Publication
(10) Pub. No.: US 2008/0303653 A1
(43) Pub. Date: Dec. 11, 2008

(54) Vehicle Locator with Optional Radar Detector

(76) Inventors: Robert Kranis, New Cumberland, WV (US); Dleine Vener, East Liverpool, OH (US)

Correspondence Address: Kathleen K. Bowen Co.LPA, 311 Hillbrook Dr, Cuyahoga Falls, OH, 44223, US

(21) Appl. No.: 12/027,987

(22) Filed: Feb. 7, 2008

Related U.S. Application Data
(60) Provisional application No. 60/888,758, filed on Feb. 7, 2007.

(51) Int. Cl. B60Q 1/26

(52) U.S. Cl. 340/468

(57) ABSTRACT

A vehicle locating system comprises a transmitting unit, a receiving unit, a power supply, a light mechanism, and a receiver switch. The transmitting unit has a transmitter, which has a signal button. When looking for their car, a user would push the signal button, which causes the transmitter to transmit a signal. The receiving unit has a receiver, set to receive the signal type sent by the transmitter. When the receiver receives the signal, it closes the receiver switch, closing the circuit, and thus lighting the lighting mechanism. The receiving unit may also be a radar detector.

### CROSS-REFERENCE TO RELATED APPLICATIONS

This application claims the benefit of U.S. Provisional Application No. 60/888,758, filed Feb. 7, 2007.

### BACKGROUND

The present invention is in the field of car locating systems. More specifically this invention relates to a system for locating a car visually, which system may also be used as a radar detector.

There are many patents dealing with locating a vehicle, for instance in a large parking lot, where the driver may not remember where it is parked. Many of these locators are mounted on the outside of the vehicle, such as on the antennae, roof, or outer side of the rear window. This leaves these devices open to damage from the weather, or theft. There are also devices which make use of the cars headlights or horn. These require either install at manufacture, or complicated install after the fact.

There is a device U.S. Pat. No. 6,127,920 to Chen, which is located inside of the vehicle, and which stands alone from the car circuitry. However, this device is also a burglar alarm, and requires a central processing controlling unit to function properly.

There is desired a simple vehicle locator device which can be located internally to the car, without requiring any installation by the user, and which does not require a processor, or complicated control unit.

### SUMMARY OF INVENTION

A vehicle locating system comprises a transmitting unit, a receiving unit, a power supply, a light mechanism, and a receiver switch. The transmitting unit has a transmitter, which has a signal button. When looking for their car, a user would push the signal button, which causes the transmitter to transmit a signal. The receiving unit has a receiver, set to receive the signal type sent by the transmitter. When the receiver receives the signal, it closes the receiver switch, closing the circuit, and thus lighting the lighting mechanism. The receiving unit may also be a radar detector.

### BRIEF DESCRIPTION OF DRAWINGS

FIG. 1 is a front view of vehicle locator receiving unit according to an aspect of the invention.

FIG. 2 is a top view of a vehicle locator transmitting unit according to an aspect of the invention.

FIG. 3 is a schematic view of a vehicle locator receiving unit according to an aspect of the invention.

FIG. 4 is a schematic view of a vehicle locator receiving unit according to an aspect of the invention.

### DETAILED DESCRIPTION

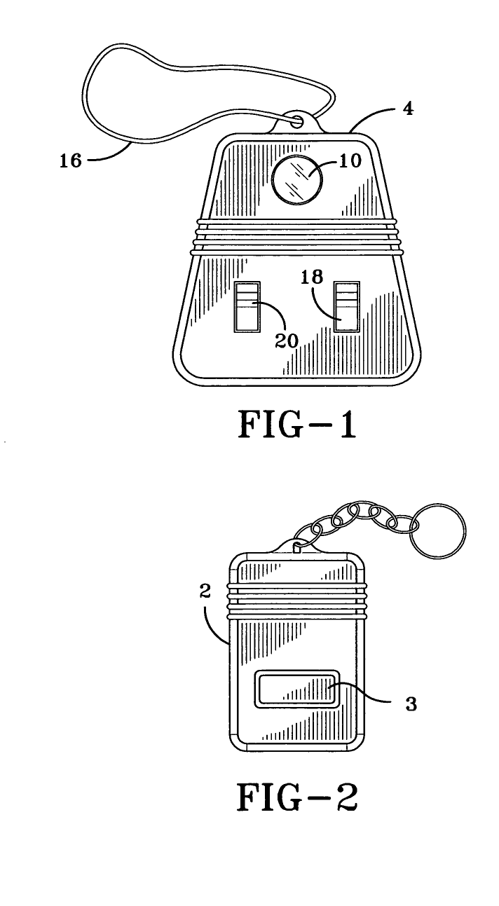

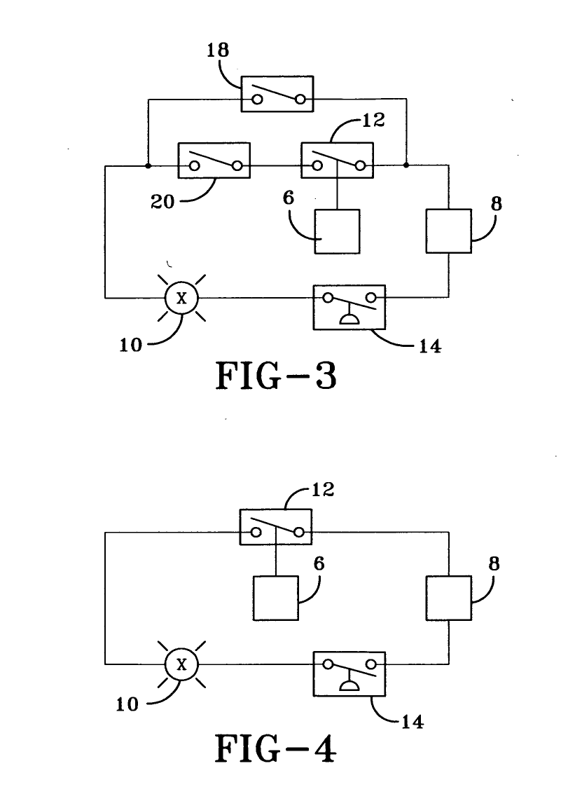

Various aspects of the invention are presented in FIGS. 1-4 which are not drawn to scale and in which like components are numbered alike. Referring now to FIGS. 1-4, according to an aspect of the invention, a vehicle locating system comprises a transmitting unit 2, a receiving unit 4, a power supply 8, a light mechanism 10, and a receiver switch 12. The transmitting unit 2 has a transmitter, which has a signal button 3. When looking for their car, a user would push the signal button 3, which causes the transmitter 2 to transmit a signal. The receiving unit 4 has a receiver 6, set to receive the signal type sent by the transmitter 2. The power supply 8 is located in the receiving unit 4. The light mechanism 10 is located in the receiving unit 4, and the light mechanism 10 is in series with the power supply 8. The receiver switch 12 is in series with the power supply 8 and the light mechanism 10. The receiver switch 12 is open and shut by the receiver 6.

According to a further aspect of the invention, the vehicle locating system further comprises a flashing unit 14 in series with the light mechanism 10, and the power supply 8, such that when the vehicle locating system is activated, the light mechanism 10 flashes.

According to a further aspect of the invention, the receiver 6 is a radar detector.

The receiving unit 4 is shown with a hanging mechanism 16, which is shown as a hanging loop 16 for hanging the unit from the rearview mirror. The hanging mechanism may be any suitable mechanism which is of a size and shape to allow the receiving unit to be hung from a rearview mirror. This loop may be adjustable. The unit is also shaped to sit on the car dash, such that the light mechanism 10 would shine upward and outward. When driving, if the unit has a radar detector for a receiver 6, the receiving unit 4 may be faced inward, such that the light mechanism 10 would flash towards the driver, indicating radar had been detected.

According to a further aspect of the invention, there is a manual light switch 18 in series with the power supply 8, but in parallel with receiver switch 12. This is so the light mechanism may be manually turned on or off. For instance, if the vehicle is stuck on the side of the road, the driver may turn the switch on, to activate the light mechanism 10 as a warning light to oncoming motorists.

According to a further aspect of the invention, there is a further power switch 20 which is in series with the power supply 8, and in series with the receiver switch 12. This power switch 20 would be left on (in the switch-closed position) when the unit is to operate as either a vehicle locator, or a radar detector; and the operation of the unit would be just as if there was no power switch 20. However, if being used with a radar detector, once the radar has been detected, the driver may wish to manually switch the light mechanism off, so as not to interfere with driving, thus he would turn the power switch 20 OFF, or if the driver does not want to detect radar, he may turn the power switch 20 OFF.

FIG. 4 shows a simple version of the receiving unit, wherein there are no extraneous switches. According to an aspect of the invention, there is a reset button 14, which is pushed to reset the receiver switch 12 to the open position after the vehicle is located.

The power supply may be any appropriate power supply, such as any type of battery. The device can also be configured to plug into the car battery, via the power outlets in the car.

I claim:

1. A vehicle locating system comprising:
a transmitting unit having a transmitter;
a receiving unit having a receiver;
a power supply in said receiving unit;
a light mechanism in said receiving unit, wherein said light mechanism is in series with said power supply; and,
a receiver switch in series with said power supply and said light mechanism, wherein said switch is open and shut by said receiver.

2. The vehicle locating system of claim 1 further comprising a flashing unit in series with said light mechanism, such that when power flows to said light mechanism, said light mechanism flashes.

3. The vehicle locating system of claim 1 wherein said receiving unit is a radar detector.

4. The vehicle locating system of claim 1 wherein said receiving unit is of a size and shape to sit easily on a car dash, without obstructing a driver's view.

5. The vehicle locating system of claim 1 wherein said receiving unit has two opposing sides, wherein said light mechanism is visible only from one side.

6. The vehicle locating system of claim 1 wherein said receiving unit further comprises a hanging mechanism, of a size and shape to hang said receiving unit from a rearview mirror.

7. The vehicle locating system of claim 1 wherein said receiving unit further comprises a power switch, wherein said power switch is in series with said receiver switch, wherein said power switch is manually operated.

8. The vehicle locating system of claim 3 wherein said receiving unit further comprises a light switch, wherein said light switch is in series with said power supply, and in parallel with said receiver switch, wherein closing said light switch will result in lighting of said light mechanism.

9. The vehicle locating system of claim 1 wherein said power supply is a battery.

10. The vehicle locating system of claim 1 wherein said power supply is an adapter for connection to a cars power outlet.
